(19) United States
(12) Patent Application Publication
(10) Pub. No.: US 2013/0018559 A1
(43) Pub. Date: Jan. 17, 2013

(54) METHOD FOR IMPLEMENTING AN EMERGENCY BRAKING OPERATION

(71) Applicants: Stefan Epple, Stuttgart (DE); Jochen Wagner, Moeglingen (DE)

(72) Inventors: Stefan Epple, Stuttgart (DE); Jochen Wagner, Moeglingen (DE)

(21) Appl. No.: 13/520,148

(22) PCT Filed: Jan. 10, 2011
(86) PCT No.: PCT/EP2011/050218

§ 371 Date: Sep. 25, 2012

(30) Foreign Application Priority Data
Mar. 4, 2010 (DE) 10 2010 002 574.7

(51) Int. Cl. B60T 8/17; B60T 8/32

(52) U.S. Cl. 701/70

(57) ABSTRACT

In a method for implementing an emergency braking operation with the aid of a brake assistance system in a vehicle, a brake actuation specified by the driver is amplified, the deactivation of the brake force amplification taking place in at least two stages.

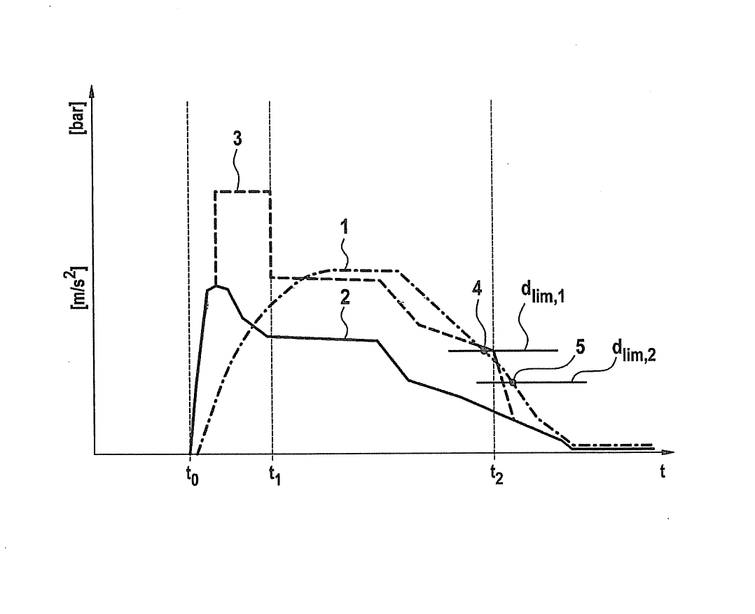

### FIELD OF THE INVENTION

The present invention relates to a method for implementing an emergency braking operation with the aid of a brake assistance system in a vehicle.

### BACKGROUND INFORMATION

German Patent Application No. DE 199 36 436 A1 describes detecting an emergency braking situation in a vehicle on the basis of the change in a rotary acceleration of at least one wheel, and generating additional brake force via a brake assistance system implemented in the vehicle brake system, which brake force is superposed to the brake force generated by the driver and increases it. To activate the brake force amplification, different threshold values for the change in the angular velocities of the vehicle wheels are specified, the values being determined from measured wheel speeds. The actuation speed of the brake pedal is utilized as additional criterion for the triggering of the brake force amplification. Apart from the combination of different criteria, improved plausibilization is achieved in order to ensure that the brake force amplification is actually generated only in emergency braking situations.

In the same way as required for the triggering of the brake force amplification, criteria for terminating the brake force amplification should be defined as well.

### SUMMARY

An object of the present invention is to terminate the brake force amplification in a vehicle brake system equipped with a brake assistance system in order to conclude an emergency braking operation in a comfortable and safe manner.

An example method for implementing an emergency braking operation requires a vehicle brake system having a brake assistance system, via which a brake force amplification is able to be implemented in emergency situations, in which a supplementary brake force is automatically generated in addition to the brake force generated by the driver. To trigger the brake force amplification, vehicle state or vehicle system quantities are analyzed, which are based on data detected by sensors, in particular, such as information from wheel speed sensors. If the criteria or threshold values defined for triggering the brake force amplification are satisfied, brake force amplification takes place, which lasts until the conditions formulated for terminating the brake force amplification are at hand.

According to a first aspect of an example embodiment of the present invention, the deactivation of the brake force amplification is carried out in at least two stages; in a first stage, once a first limit value of the state quantity has been attained, the brake force amplification is initially reduced to a smaller value; and in a further stage, once a further limit value for a state quantity has been attained, the brake force amplification is reduced down to zero. A reduction of the brake force amplification in at least two stages is involved, it also being possible to consider a greater number of stages, such as three stages or four stages. The stepwise reduction of the brake force amplification has the advantage that it allows a better adaptation to the current driving situation via the specification of the associated limit values or threshold values. For example, the individual brake force amplification may be retained for a different length of time at each stage, depending on the current situation, which length of time is defined as a function of additional state quantities or other current vehicle characteristics.

According to one useful further development, the state quantity which is analyzed for terminating the brake force amplification is the vehicle deceleration or a correlating variable such as the change in the angular wheel velocity at one or a plurality of vehicle wheel(s). The same state quantities are expediently considered for the different stages in the reduction of the brake force amplification, it basically also being possible to consider different types of state quantities with individually assigned limit values in the individual stages.

Once the final stage in the deactivation operation of the brake force amplification has been reached, the brake force amplification is reduced either immediately, so that only the driver-generated brake force takes effect within the shortest period of time, or it is reduced according to a predefined function, especially in ramp-type manner, down to zero. In general, the reduction of the brake force from stage to stage may be implemented both abruptly and in ramp-type manner or according to some other predefined function; for the switch between different stages or from the final stage to zero, both same-type reduction functions and different reduction functions are an option.

According to another aspect of the example embodiment of the present invention, the deactivation of the brake force amplification depends on the elapsing of an activation period during which the brake assistance system has been connected. This criterion is advantageously combined with the stepwise reduction of the brake force amplification, such that a reduction of the automatically generated brake force takes place as soon as one of the criteria is attained, that is to say, either a stepwise reduction or the elapsing of the defined activation period. However, an independent realization in the vehicle brake system is basically possible as well, i.e., either only the stepwise reduction or only the reduction after reaching the activation period. In the latter case, too, the brake force amplification is returned either abruptly or according to a predefined function such as in ramp-type manner.

The activation period according to the second aspect of the present invention is either predefined as fixed threshold value or determined as a function of at least one state variable or characteristic quantity of the vehicle, especially as a function of the vehicle speed, and the activation period preferably also increases with the vehicle speed. In general, one or more state variable(s) may be entered in the calculation of the activation period.

During the brake force amplification phase, i.e., even before the deactivation phase has been reached, a constant deceleration is advantageously generated via the brake force amplification, at least periodically, which is built up via the brake assistance system. Another possibility, however, is a stepped function, especially in such a way that upon the onset of the brake force amplification, hump-shaped overshooting is implemented first, which subsequently is maintained at a reduced level in comparison with the maximum value of the brake force amplification, this level preferably being constant, at least sectionally.

The detection of an emergency situation, which leads to the triggering of the brake force amplification, preferably takes place without using a pressure sensor for determining the instantaneous brake pressure. It is basically sufficient to detect an emergency situation via the analysis of the measured wheel speeds; if applicable, additional other influencing factors may be taken into account, such as the friction of the road surface, the instantaneous gradient, the instantaneous load state, chassis settings or the instantaneous brake state. Nevertheless, it may be useful to take the instantaneous brake pressure into account as well when detecting the emergency situation.

For practical reasons, the example method according to the present invention runs in a closed-loop or open-loop control device in the vehicle, which either is part of the brake system or which communicates with it.

Further advantages and expedient embodiments may be inferred from the description below and the FIGURE.

### BRIEF DESCRIPTION OF THE DRAWING

The FIGURE shows a diagram with different state quantities during the activation and deactivation of a brake assistance system.

### DETAILED DESCRIPTION OF EXAMPLE EMBODIMENTS

In the diagram, the time with plotted instants t₀, t₁, and t₂ is shown on the abscissa; on the ordinate, the dash-dot line illustrates vehicle deceleration 1 in ms/s², and driver brake pressure 2 as well as brake force amplification 3 in bar or a similar unit in each case, driver brake pressure 2 being plotted as a solid line, and brake force amplification 3 being plotted by a dashed line. The illustrated curves in the diagram indicate the activation, the implementation and the deactivation of a brake assistance system in a vehicle brake system.

The activation of the vehicle brake occurs at instant t₀, in that the driver operates the brake pedal, which can be gathered from a strong rise in driver brake pressure 2. The absolute amount of the increase in the driver brake pressure, for example, is an indication of an emergency braking operation, in which brake force amplification 3 is generated in addition to driver brake pressure 2, by connecting a brake assistance system. The emergency situation is not necessarily detected on the basis of the brake pressure; instead, the emergency situation is also detectable by analyzing other information acquired by sensors, e.g., on the basis of measured wheel speeds.

In the illustrated exemplary embodiment, the brake assistance system is connected in the region of the driver brake-pressure maximum, between instants t₀ and t₁, and brake force amplification, which initially has a characteristic that drops in stepped manner, is generated. When brake force amplification 3 is connected, it initially rises to a maximum which is maintained until instant t₁ is reached. Starting with instant t₁, brake force amplification 3 drops to a lower value, which is at least approximately constant and has a level that lies slightly above the maximum of driver brake pressure 2. Brake force amplification 3 constitutes an offset in this case, which is added to driver brake pressure 2, so that the curve of brake force amplification 3, in relation to the abscissa, represents the absolute brake pressure value which is composed of the brake pressure of the driver and the brake force amplification.

Due to the strong rise in the brake pressure, which results from superposing brake force amplification 3 to driver brake pressure 2, the characteristic of vehicle deceleration 1 increases greatly as well, and vehicle deceleration 1 reaches a maximum between instants t₁ and t₂, this maximum level being sectionally maintained until the vehicle deceleration drops down to zero or approximately zero in roughly linear fashion. The drop in vehicle deceleration 1 takes place approximately in parallel with the drop in driver brake pressure 2 and brake force amplification 3.

The deactivation process of the brake force amplification begins approximately at instant t₂. The deactivation of brake force amplification 3 may be initiated on the basis of different criteria. It is possible to specify threshold values or limit values d_{lim, 1} and d_{lim, 2} for the vehicle deceleration, in which case the deactivation process of the brake force amplification is initiated as soon as actual vehicle deceleration 1 reaches the higher limit value d_{lim, 1.} Once this limit value has been reached, the brake force amplification is reduced, preferably in ramp-type manner. If vehicle deceleration 1 drops to the lower second limit value d_{lim, 2,} the brake force amplification is reduced further, down to zero. This further drop may be implemented either at the same gradient or at a different gradient, or it is also possible that a completely different function is implemented. Limit values d_{lim, 1} and d_{lim, 2} for the vehicle deceleration are either specified as fixed threshold values or determined as a function of the particular situation from further state variables or parameters of the vehicle.

It is basically also possible that limit values d_{lim, 1} and d_{lim, 2} coincide and thus assume the same value.

Furthermore, it is also possible to initiate the deactivation process when reaching a time threshold, such as when reaching instant t₂, this deactivation instant t₂ being defined from an activation period t_{act} whose onset coincides with the activation of the brake force amplification. As soon as the activation period starting from this instant has elapsed, which is the case at instant t₂, the deactivation process of the brake force amplification begins, which then is systematically returned to zero.

According to one advantageous development, a combination of different criteria is provided for the deactivation of brake force amplification 3. It is possible, in particular, to combine the various threshold or limit values with regard to a state variable of the vehicle, at the attainment of which the deactivation process is initiated, with a time threshold. In the exemplary embodiment, this means that the deactivation process is initiated as soon as one of the various criteria for the start of the deactivation is attained, which is the case, for example, when the vehicle deceleration drops below limit value d_{lim, 1}, provided activation period t_{act} is not exceeded first.

1-10. (canceled)

11. A method for implementing an emergency braking operation with the aid of a brake assistance system in a vehicle, in which a brake actuation specified by a driver is amplified by the brake assistance system, the method comprising:
deactivating a brake force amplification in at least two stages, wherein in a first stage, once a first state variable limit value has been reached, the brake force amplification is reduced and in a further stage, once a further state variable limit value has been reached, the brake force amplification is reduced down to zero.

12. The method as recited in claim 11, wherein the first state variable is one of a vehicle deceleration or a variable correlating with the vehicle deceleration.

13. The method as recited in claim 11, wherein once the further state variable limit value has been reached, the brake force amplification is reduced immediately.

14. The method as recited in claim 11, wherein the deactivation of the brake force amplification is implemented after the brake assistance system has been connected for a defined activation period.

15. The method as recited in claim 14, wherein the activation period is specified as a fixed threshold value.

16. The method as recited in claim 14, wherein the activation period is determined as a function of a vehicle speed.

17. The method as recited in claim 11, wherein the reduction of the brake force amplification is implemented in ramp-type manner.

18. The method as recited in claim 11, wherein a constant, additional deceleration is generated via the brake assistance system prior to deactivating the brake force amplification.

19. The method as recited in claim 11, wherein an emergency situation which activates the brake assistance system is detected without a pressure sensor.

20. A control device for implementing an emergency braking operation with the aid of a brake assistance system in a vehicle, in which brake actuation specified by a driver is amplified by the brake assistance system, the control device configured to deactivate a brake force amplification in at least two stages, wherein in a first stage, once a first state variable limit value has been reached, the brake force amplification is reduced and in a further stage, once a further state variable limit value has been reached, the brake force amplification is reduced down to zero.
